(19) United States
(12) Patent Application Publication
(10) Pub. No.: US 2013/0301195 A1
(43) Pub. Date: Nov. 14, 2013

(54) TOUCH DISPLAY DEVICE AND DRIVING METHOD THEREOF

(71) Applicants: Cheng-Yen Yeh, Taichung City (TW); Yu-Ting Chen, Taoyuan County (TW); Chen-Hao Su, Taichung City (TW)

(72) Inventors: Cheng-Yen Yeh, Taichung City (TW); Yu-Ting Chen, Taoyuan County (TW); Chen-Hao Su, Taichung City (TW)

(73) Assignee: WINTEK CORPORATION, Taichung City (TW)

(21) Appl. No.: 13/890,269

(22) Filed: May 9, 2013

(30) Foreign Application Priority Data
May 9, 2012 (TW) 101116567

(51) Int. Cl. G06F 3/01

(52) U.S. Cl. CPC G06F 3/011
USPC 361/679.01

(57) ABSTRACT

A touch display device includes a display panel, a plurality of first sensing-series and a plurality of second sensing-series. The display panel includes a first substrate, a second substrate, a plurality of pixel structures and the display medium located between the first substrate and the second substrate. The first sensing-series are on the first substrate. The second sensing-series are on the second substrate.

### CROSS-REFERENCE TO RELATED APPLICATION

This application claims the priority benefit of Taiwan application serial no. 101116567, filed on May 9, 2012. The entirety of the above-mentioned patent application is hereby incorporated by reference herein and made a part of this specification.

### BACKGROUND OF THE INVENTION

1. Field of the Invention

The invention generally relates to a touch display device, and more particularly, to a touch display device with touch function on double surfaces.

2. Description of Related Art

Due to the interface user-friendly advantage of a touch panel, the touch panel has been widely used in various electronic products, especially in mobile electronic products such as mobile phone, tablet computer. However, in the prior art, a kind of touch display device formed by adhering a plug-in touch panel to a display panel features a larger thickness to make it slimming difficulty in the applied mobile electronic products. In this regard, an integrated touch display device formed by integrate a touch panel into a display panel was launched.

### SUMMARY OF THE INVENTION

Accordingly, the invention is directed to a touch display device with touch function on double surfaces and easy way for slimming and able to reduce the capacitive overload between common electrodes and sensing-series in the prior art.

The invention is also directed to a driving method of a touch display device, which is suitable for driving the touch display device of the invention so as to make the touch display device of the invention have display and touching functions.

The invention is further directed to another driving method of a touch display device, which is also suitable for driving the touch display device of the invention so as to make the touch display device of the invention have display and touching functions.

The invention provides a touch display device including a display panel, a plurality of first sensing-series and a plurality of second sensing-series. The display panel includes a first substrate, a second substrate, a plurality of pixel structures and a display medium. The first substrate has a first inner-surface and a first outer-surface opposite to the first inner-surface. The second substrate has a second inner-surface and a second outer-surface opposite to the second inner-surface. The pixel structures are located between the first inner-surface and the second inner-surface. The display medium is located between the first substrate and the second substrate. The first outer-surface is located between the first sensing-series and the first inner-surface, and the first sensing-series are insulated from each other. The second outer-surface is located between the second sensing-series and the second inner-surface, and the second sensing-series are electrically insulated from each other.

According to an embodiment of the invention, the touch display device further comprises a plurality of first electrode-structures and a plurality of second electrode-patterns. The first electrode-structures are located between the first inner-surface and the pixel structures. The first electrode-structures are electrically insulated from each other. The second electrode-patterns are located between the pixel structures and the second inner-surface. The second electrode-patterns are electrically insulated from each other. The first sensing-series are crossed with the first electrode-structures. The second sensing-series are crossed with the second electrode-patterns.

According to an embodiment of the invention, the first electrode-structures are the first common-electrode-structures and each of the first common-electrode-structures comprises a plurality of first common-electrode-patterns electrically connected to each other, and the second electrode-patterns are the second common-electrode-patterns

According to an embodiment of the invention, the second common-electrode-patterns are respectively electrically connected to the first common-electrode-structures.

The invention provides a driving method of a touch display device suitable for driving the above-mentioned touch display device, wherein the driving method includes: respectively inputting a plurality of sensing driving-signals in a fixed frequency within a frame-updating duration to a plurality of first common-electrode-structures, wherein a plurality of active devices of the pixel structures during inputting the sensing driving-signals are in turning-off state.

The invention further provides another driving method of a touch display device suitable for driving the above-mentioned touch display device, wherein the driving method includes: respectively inputting a plurality of sensing driving-signals to a plurality of first electrode-structures after updating a frame but prior to updating the next frame, wherein a plurality of active devices of the pixel structures during inputting the sensing driving-signals are in turning-off state.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a top-view perspective diagram of a first substrate of a touch display device according to the first embodiment of the invention.

FIG. 2 is a top-view perspective diagram of a second substrate of a touch display device according to the second embodiment of the invention.

FIG. 3 is a cross-sectional diagram of the touch display device on the column direction according to the first embodiment of the invention.

FIG. 4 is a cross-sectional diagram of the touch display device on the row direction according to the first embodiment of the invention.

FIG. 5 is a diagram showing the first common-electrode-structures of FIG. 1.

FIG. 6 is a diagram showing the second common-electrode-patterns and the second sensing-series of FIG. 2.

FIG. 7A is a top-view diagram of first sensing-series (or the second sensing-series) according to an embodiment of the invention.

FIG. 7B is a top-view diagram of first sensing-series (or the second sensing-series) and first dummy sensing-pads (or second dummy sensing-pads) according to another embodiment of the invention.

FIG. 8A is a cross-sectional diagram of a touch display device according to the first embodiment of the invention.

FIG. 8B is a cross-sectional diagram of a touch display device according to another embodiment of the invention.

FIG. 9 is a cross-sectional diagram of a touch display device according to the first embodiment of the invention.

FIG. 10 is a diagram showing the first common-electrode-structures of FIG. 9.

FIG. 11 is a cross-sectional diagram of a touch display panel after modularization according to the first embodiment of the invention.

FIG. 12 is a cross-sectional diagram of a touch display panel after modularization according to another embodiment of the invention.

FIG. 13 is a driving diagram of the touch display device according to the first embodiment of the invention.

FIG. 14 is a diagram showing the sensing driving-signal and the reference voltage input to the first common-electrode-structures and the second common-electrode-patterns, the scan signal input to the gates of the pixel structures and the displaying signal input to the sources of the pixel structures according to the first embodiment of the invention.

FIG. 15 is a diagram showing the sensing driving-signal and the reference voltage input to the first common-electrode-structures and the second common-electrode-patterns, the scan signal input to the gates of the pixel structures and the displaying signal input to the sources of the pixel structures according to another embodiment of the invention.

FIG. 16 is a cross-sectional diagram of a touch display device according to the second embodiment of the invention.

FIG. 17 is an equivalent circuit diagram of the display panel of FIG. 16.

FIG. 18 is a top-view perspective diagram of the touch display device of FIG. 16.

### DESCRIPTION OF THE EMBODIMENTS

The touch display device of one embodiment of the invention has touch function on double surfaces and is easier for slimming. In more details, the touch display device of one embodiment of the invention has two sets of sensing-series along different extension directions respectively disposed at an inner side and an outer side of a first substrate of a display panel so as to form a first touch-sensing layer. The touch display device of one embodiment of the invention has another two sets of sensing-series along different extension directions respectively disposed at an inner side and an outer side of a second substrate of the display panel so as to form a second touch-sensing layer. In this way, at least two users can operate the touch display device of one embodiment of the invention at both sides of the touch display device by respectively using the first touch-sensing layer and the second touch-sensing layer, which makes interactive operations between the two users more convenient and more quickly.

It should be noted that in the touch display device of one embodiment of the invention, the sensing-series located at the inner side of the first substrate and at the inner side of the second substrate are fabricated by respectively using the first electrode-structures and the second electrode-patterns, for example the first electrode-structures are the first common-electrode-structures and the second electrode-patterns are the second common-electrode-patterns of the display panel, so that the touch display device of one embodiment of the invention is able to achieve touch function on double surfaces, which further advances the touch effect of the touch display device. Some figures are shown in following to explain the embodiments of the invention.

### The First Embodiment

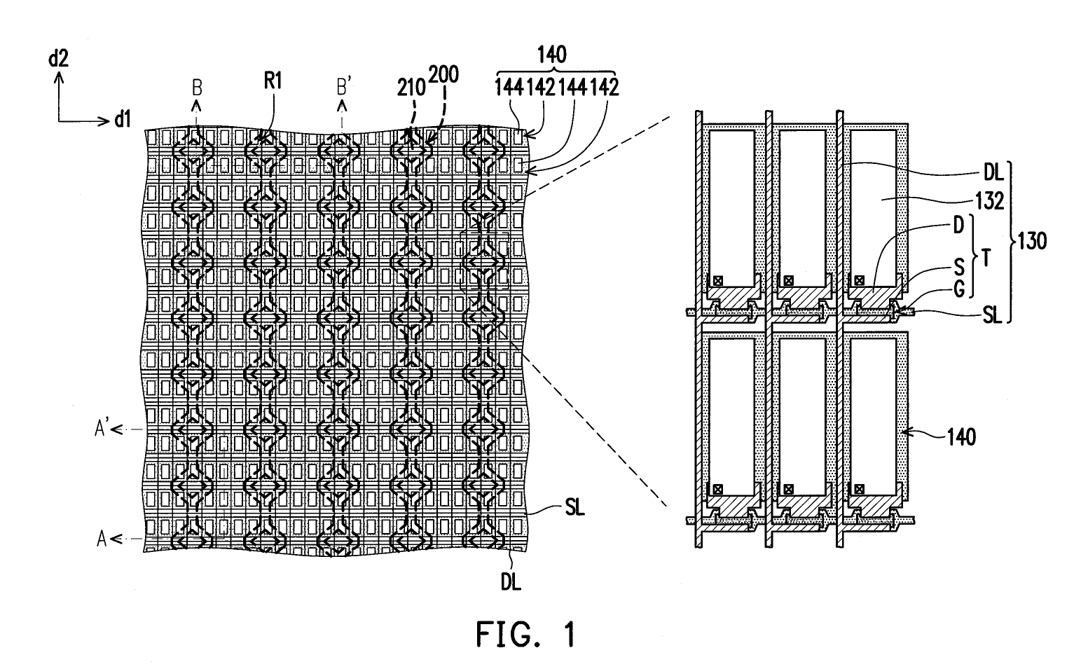

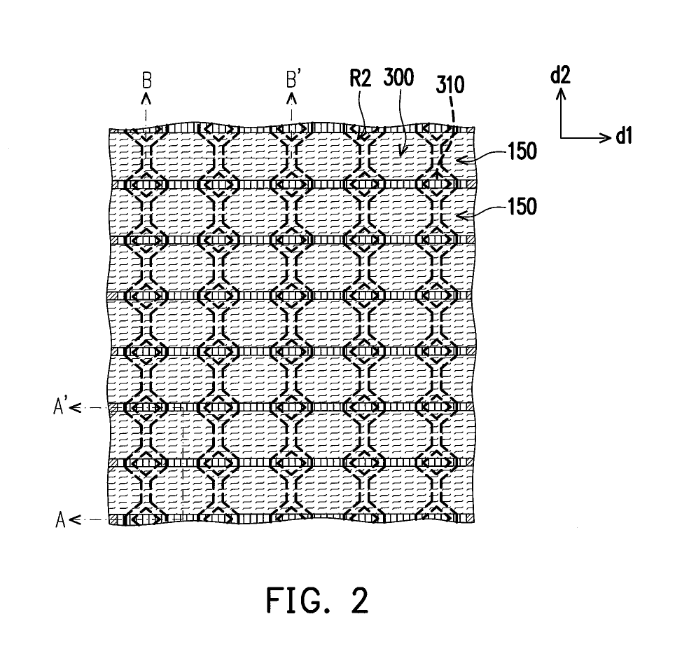

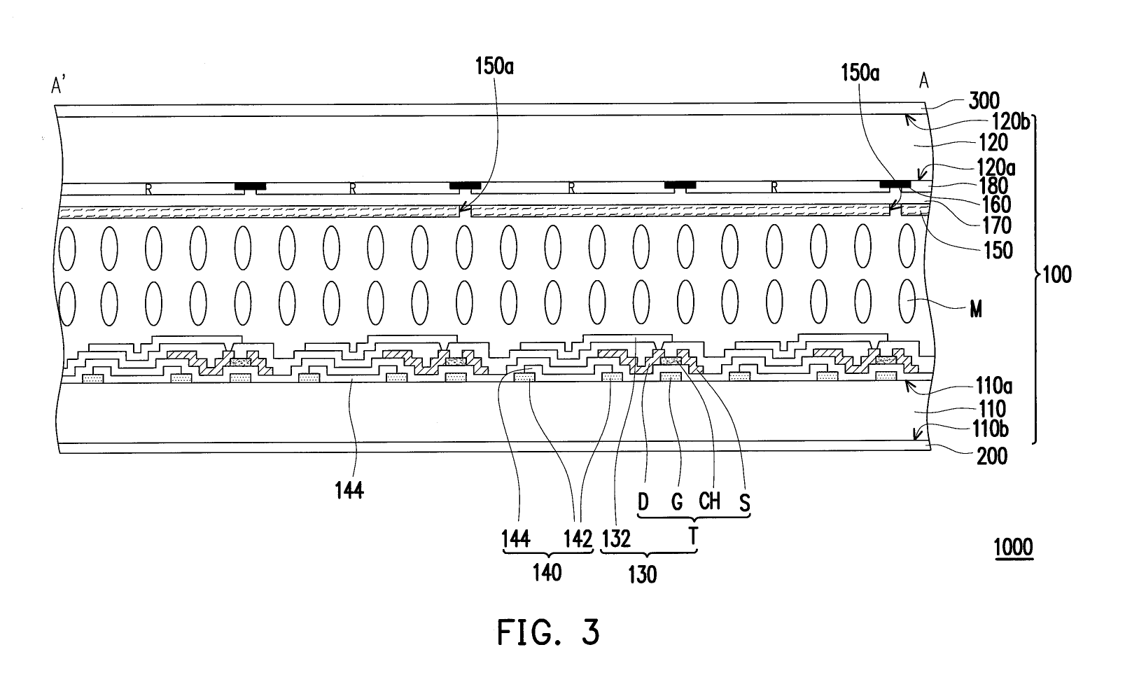

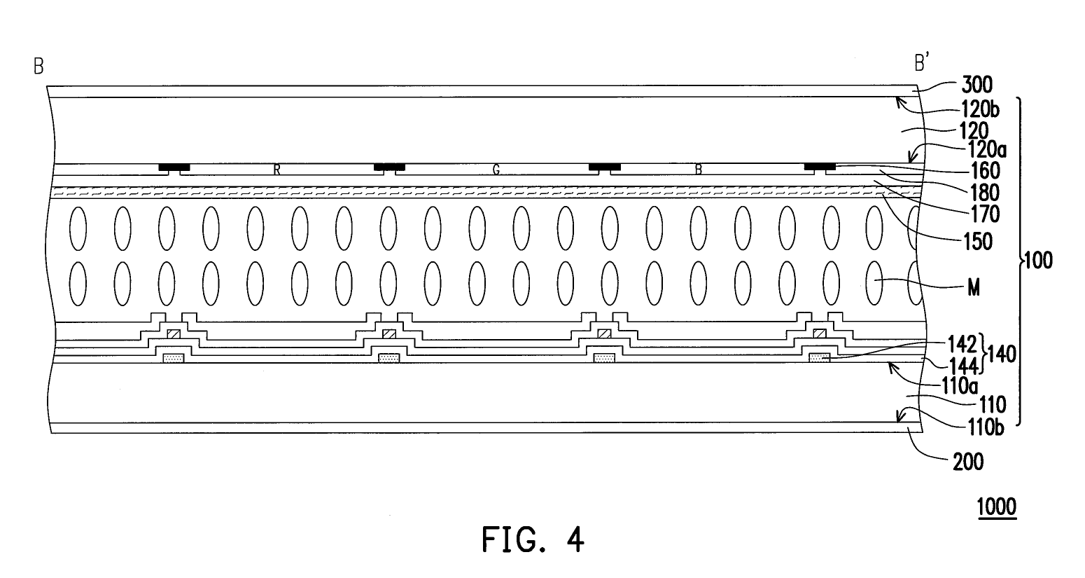

FIG. 1 is a top-view perspective diagram of a first substrate of a touch display device according to the first embodiment of the invention, FIG. 2 is a top-view perspective diagram of a second substrate of a touch display device according to the second embodiment of the invention, FIG. 3 is a cross-sectional diagram of the touch display device on the column direction according to the first embodiment of the invention and FIG. 4 is a cross-sectional diagram of the touch display device on the row direction according to the first embodiment of the invention. In particular, FIG. 3 is corresponding to the section line AA′ in FIGS. 1 and 2 and FIG. 4 is corresponding to the section line BB′ in FIGS. 1 and 2.

Referring to FIGS. 1, 2, 3 and 4, a touch display device 1000 of the embodiment includes a display panel 100, a plurality of first sensing-series 200 and a plurality of second sensing-series 300. The display panel 100 includes a first substrate 110 with a first inner-surface 110a and a first outer-surface 110b, a second substrate 120 with a second inner-surface 120a and a second outer-surface 120b, a plurality of pixel structures 130 located between the first inner-surface 110a and the second inner-surface 120a, a plurality of first common-electrode-structures 140 located between the first inner-surface 110a and the pixel structures 130, a plurality of second common-electrode-patterns 150 located between the pixel structures 130 and the second inner-surface 120a and a display medium M located between the first substrate 110 and the second substrate 120. The first outer-surface 110b is located between the first sensing-series 200 and the first inner-surface 110a. In other words, in the embodiment, the first sensing-series 200 can be located on the first outer-surface 110b and contact the first outer-surface 110b. The second outer-surface 120b is located between the second sensing-series 300 and the second inner-surface 120a. That is to say, in the embodiment, the third sensing-series 300 can be located on the second outer-surface 120b and contact the second outer-surface 120b.

In the embodiment, the first common-electrode-structures 140 of the display panel 100 and the first sensing-series 200 together form a first touch-sensing layer for a user beside the first substrate 110 to operate. On the other hand, the second common-electrode-patterns 150 of the display panel 100 and the second sensing-series 300 together form a second touch-sensing layer for another user beside the second substrate 120 to operate. In this way, the display panel 100 of the embodiment can have touch function on double surfaces. Since partial first touch-sensing layer and partial second touch-sensing layer are fabricated from the inner structures of the display panel 100 (i.e., the first common-electrode-structures 140 and the second common-electrode-patterns 150), so that the touch display device 1000 of the embodiment is easier to get slimming shape. In following, some figures are given to explain in details how the partial first touch-sensing layer and the partial second touch-sensing layer are fabricated from the inner structures of the display panel.

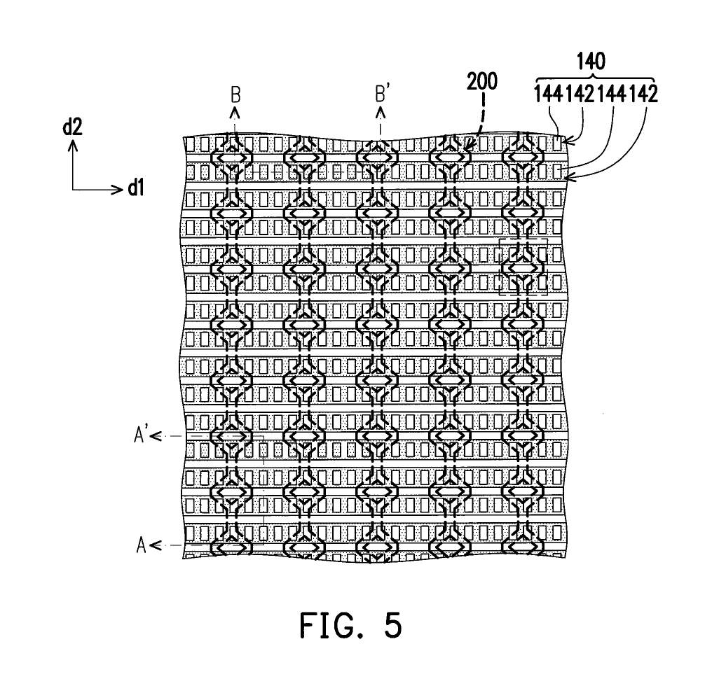

FIG. 5 is a diagram showing the first common-electrode-structures and the first sensing-series of FIG. 1. Referring to FIGS. 1 and 5, the display panel 100 of the embodiment includes a plurality of first common-electrode-structures 140 electrically insulated from each other. Referring to FIGS. 1 and 3, in the embodiment, the first common-electrode-structures 140 on the first inner-surface 110a and the first sensing-series 200 on the first outer-surface 110b are crossed with each other and insulated from each other to form the first touch-sensing layer. The first touch-sensing layer is used for the user beside the first outer-surface 110b to perform touch operation. In other words, in addition to serving as a common electrode of the display panel, each of the first common-electrode-structures 140 can serve as the sensing-series of the first touch-sensing layer as well.

As shown by FIGS. 1 and 5, each of the first common-electrode-structures 140 in the embodiment includes two first common-electrode-patterns 142. Each of the first common-electrode-patterns 142 is, for example, a long-bar pattern with a plurality of openings and formed by connecting a plurality of square-shape patterns, which and the shape of the first common-electrode-patterns 142 and the number of the first common-electrode-patterns 142 in each first common-electrode-structure 140, the invention is not limited to, and an appropriate other design is allowed according to the real requirement.

Referring to FIGS. 1 and 3, in the embodiment, the first common-electrode-patterns 142 and gates G of the pixel structures 130 can belong to a same layer. Considering the conductivity, the first common-electrode-patterns 142 are preferably made of metal material, which the invention is not limited to. In other embodiments, the first common-electrode-patterns 142 and the sources S and drains D of the pixel structures 130 can belong to the same layer, in which the first common-electrode-patterns 142 can be made of other conductive materials, for example, alloy, metal nitride, metal oxide, metal nitrogen oxide, or stacked layers of metal material and other conductive materials.

It should be noted that considering the touch display device 1000 of the embodiment uses the first common-electrode-structures 140 as a sensing-series of the first touch-sensing layer, the touch display device 1000 of the embodiment thereby is able to reduce the capacitive overload between common electrodes and sensing-series in the conventional in-cell architecture of display panel and further to reduce the poor touch effect problem.

Referring to FIGS. 1 and 3 again, in order to increase the coupling area between the first common-electrode-structures 140 and the first sensing-series 200 so as to advance the touch effect of the touch display device 1000, each of the first common-electrode-structures 140 in the embodiment can optionally include a plurality of transparent electrodes 144. The transparent electrodes 144 can be located between the pixel structures 130 and the first inner-surface 110a, and each of the transparent electrodes 144 is respectively electrically connected to a plurality of first common-electrode-patterns 142 in one of first common-electrode-structures 140. In more details, as shown by FIG. 3, the transparent electrode 144 of the embodiment can directly overlay the first common-electrode-patterns 142 to be electrically connected to the first common-electrode-patterns 142. For obtaining sufficient coupling area, the transparent electrodes 144 of the embodiment can overlay the pixel electrodes 132 of the pixel structures 130. In addition, to avoid affecting the normal display function of the pixel structures 130, the transparent electrodes 144 can adopt transparent conductive material, for example, indium tin oxide (ITO), indium zinc oxide (IZO), aluminium tin oxide (ATO), aluminium zinc oxide (AZO), indium germanium zinc oxide (IGZO), or other suitable oxides or stacked layers formed by at least two above-mentioned materials.

FIG. 6 is a diagram showing the second common-electrode-patterns and the second sensing-series of FIG. 2. Referring to FIGS. 3 and 6, a plurality of second common-electrode-patterns 150 of the embodiment are located between the pixel structures 130 and the second inner-surface 120a and electrically insulated from each other. In other words, the touch display device 1000 of the embodiment cuts an entire common-electrode-pattern on the second substrate in a conventional display panel into a plurality of second common-electrode-patterns 150 extending towards a row-direction dl.

As shown by FIG. 6, in more details, the second common-electrode-patterns 150 on the second inner-surface 120a in the embodiment and the second sensing-series 300 on the second outer-surface 120b are crossed with each other and insulated from each other to form the second touch-sensing layer. The second touch-sensing layer provides the user beside the second outer-surface 120b with touch operation, so that in addition to serving as the common-electrodes of the display panel 100, the second common-electrode-patterns 150 can serve as a sensing-series of the second touch-sensing layer as well.

Moreover, in order to avoid possible light-leaking phenomena caused by edges 150a between adjacent second common-electrode-patterns 150 to affect the optical performance of the touch display device 1000, as shown by FIG. 3, the position of the second common-electrode-patterns 150 in the embodiment is specified through appropriate design. That is, the display panel 100 of the embodiment can further include a light-shielding layer 160 located between the second inner-surface 120b and the second common-electrode-patterns 150. Each of the second common-electrode-patterns 150 has at least one edge 150a adjacent to other second common-electrode-patterns 150. The light-shielding layer 160 covers the edges 150a, so that the possible leaking light caused by the edges 150a of the second common-electrode-patterns 150 can be shielded and the touch display device 1000 of the embodiment can maintain the good optical performance.

To shrink the light-leaking range, as shown by FIGS. 3 and 4, the touch display device 1000 of the embodiment further includes a passivation layer 170. The passivation layer 170 entirely overlays the light-shielding layer 160 and is located between the second common-electrode-patterns 150 and the light-shielding layer 160, in which the passivation layer 170 fills up the breaking gaps caused by a color resistant layer 180 to further shrink the light-leaking range possibly caused by the edges 150a of the second common-electrode-patterns 150. In this way, the touch display device 1000 of the embodiment can effectively maintain the excellent optical performance.

Considering visual uniformity of the touch display device 1000, referring to FIG. 1 (and FIG. 2), a plurality of first dummy sensing-pads 210 (and a plurality of second dummy sensing-pads 310) are disposed at gap places R1 between the first sensing-series 200 in the embodiment (and gap places between the second sensing-series 300), in which the first dummy sensing-pads 210 (and the second dummy sensing-pads 310) are floating and together with the first sensing-series 200 (or the second sensing-series 300) belong to the same layer. The first dummy sensing-pads 210 (and the second dummy sensing-pads 310) can reduce the areas of the gap places R1 between the first sensing-series 200 so that the user is not easily observe out the profile of the first sensing-series 200 (or the second sensing-series 300) and the visual uniformity of the touch display device 1000 can be further advanced.

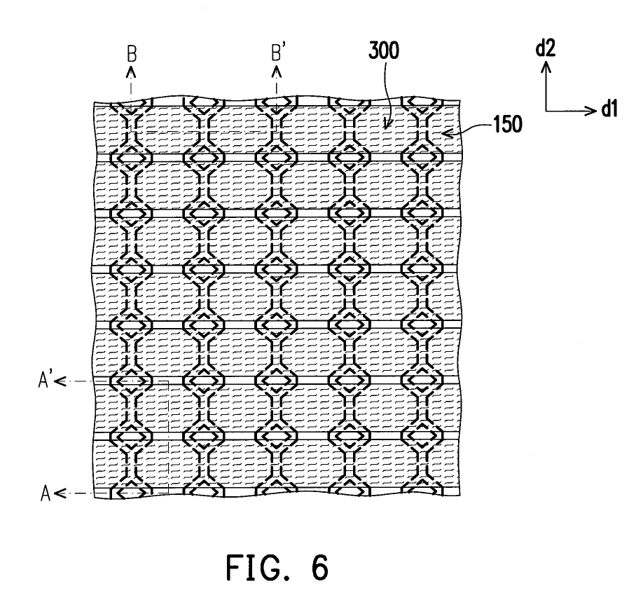

In FIGS. 1 and 2, the first sensing-series 200 and the second sensing-series 300 of the embodiment are formed through connecting a plurality of hexagon conductive patterns. In the embodiment, the first dummy sensing-pads 210 (and the second dummy sensing-pads 310) can be rhombic transparent pattern. However, the invention does not limit the shapes of the first sensing-series 200, the second sensing-series 300, the first dummy sensing-pads 210 and the second dummy sensing-pads 310, which can have appropriate other designs according to the real requirement, for example, the design of FIG. 7A. FIG. 7A is a top-view diagram of first sensing-series (or the second sensing-series) according to an embodiment of the invention. Referring to FIG. 7A, in the embodiment, a first sensing-series 200A (or a second sensing-series 300A) can be a long-bar like conductive pattern extending along the column direction. FIG. 7B is a top-view diagram of first sensing-series (or the second sensing-series) and first dummy sensing-pads (or second dummy sensing-pads) according to another embodiment of the invention. Referring to FIG. 7B, in the embodiment, a B (or a second sensing-series 300B) can be formed by connecting a plurality of rhombic transparent patterns, and the first dummy sensing-pads 210B (or the second dummy sensing-pads 310B) herein have rhombic shape.

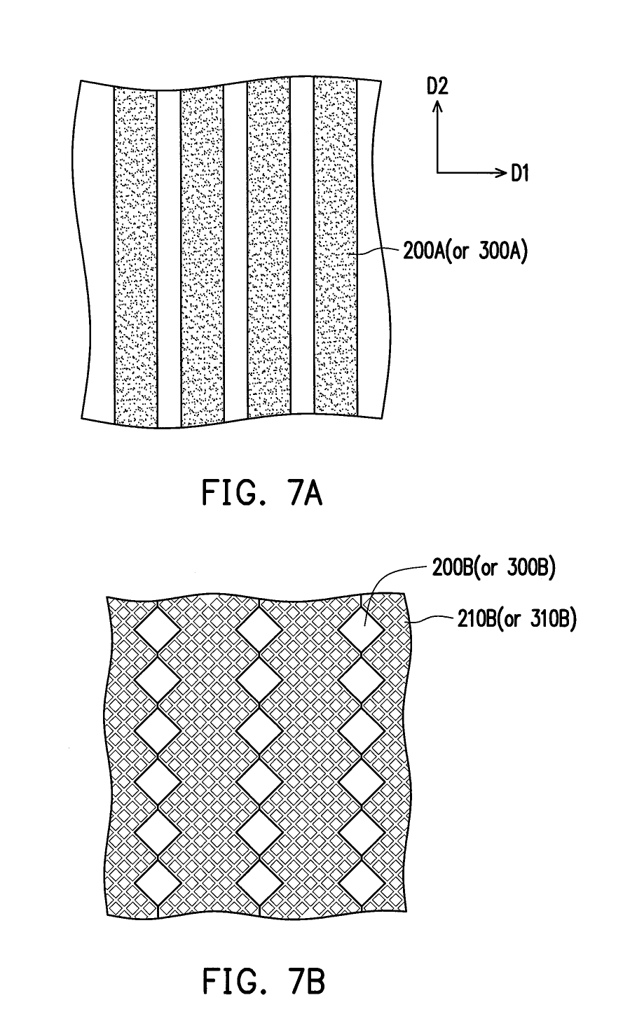

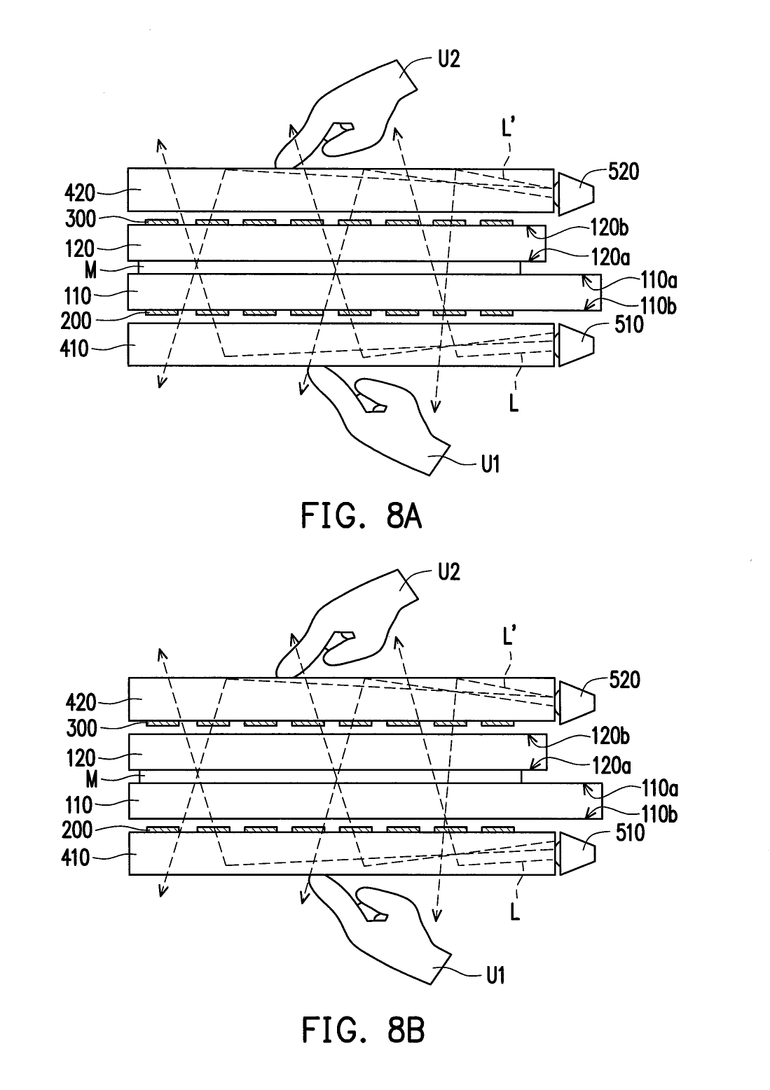

FIG. 8A is a cross-sectional diagram of a touch display device according to the first embodiment of the invention. Referring to FIG. 8A, the touch display device 1000 of the embodiment further includes a first transparent protection plate 410 and a second transparent protection plate 420. The first outer-surface 110b is located between the first inner-surface 110a and the first transparent protection plate 410, while the second outer-surface 120b is located between the second inner-surface 120a and the second transparent protection plate 420. The first transparent protection plate 410 and the second transparent protection plate 420 of the embodiment can protect the first sensing-series 200 and the second sensing-series 300 both located under them 410 and 420 from damage.

As shown by FIG. 8A, in the embodiment, the first sensing-series 200 can directly contact the first outer-surface 110b and the second sensing-series 300 can directly contact the second outer-surface 120b, which the invention is not limited to. In fact, the positions of the first sensing-series 200 and the second sensing-series 300 can be adjusted depending on different requirements, for example, the design of FIG. 8B. FIG. 8B is a cross-sectional diagram of a touch display device according to another embodiment of the invention. Referring to FIG. 8B, the first sensing-series 200 and the second sensing-series 300 of the embodiment can be respectively disposed on a first transparent protection plate 410 and a second transparent protection plate 420 and can respectively contact the first transparent protection plate 410 and the second transparent protection plate 420.

In more details, as shown by FIG. 8A, if the display medium M is non-self-luminous material, for example, liquid crystals, the first transparent protection plate 410 and the second transparent protection plate 420 can serve as light guide plate (LGP) as well, and at the time, the first transparent protection plate 410 and the second transparent protection plate 420 can respectively have at least one light-emitting component 510 and 520 therebeside. The light L emitted from the light-emitting component 510 can, via the first transparent protection plate 410, evenly penetrate the first substrate 110 and the second substrate 120 of the display panel 100 so as to provide frames to a user U2 beside the second substrate 120 for operating. On the other hand, the light L′ emitted from the light-emitting component 520 can, via the second transparent protection plate 420, evenly penetrate the first substrate 110 and the second substrate 120 of the display panel 100 so as to provide frames to another user U1 beside the first substrate 110 for operating.

It should be noted that in FIG. 8B, the first sensing-series 200 of the first touch-sensing layer is formed on the first transparent protection plate 410, while another sensing-series (i.e., the first common-electrode-structures) of the first touch-sensing layer is formed on the first substrate 110. The second sensing-series 300 of the second touch-sensing layer is formed on the second transparent protection plate 420, while another sensing-series (i.e., the second common-electrode-patterns) of the second touch-sensing series is formed on the second substrate 120. That is to say, in the embodiment, the first touch-sensing series and the second touch-sensing series can be integrated into the touch display device without using a turning-over process in the prior art to respectively fabricate the sensing-series of the first touch-sensing series (or the sensing-series of the second touch-sensing series) at both sides of the first substrate 110 (or the second substrate 120). As a result, the touch display device of FIG. 8B has high production yield.

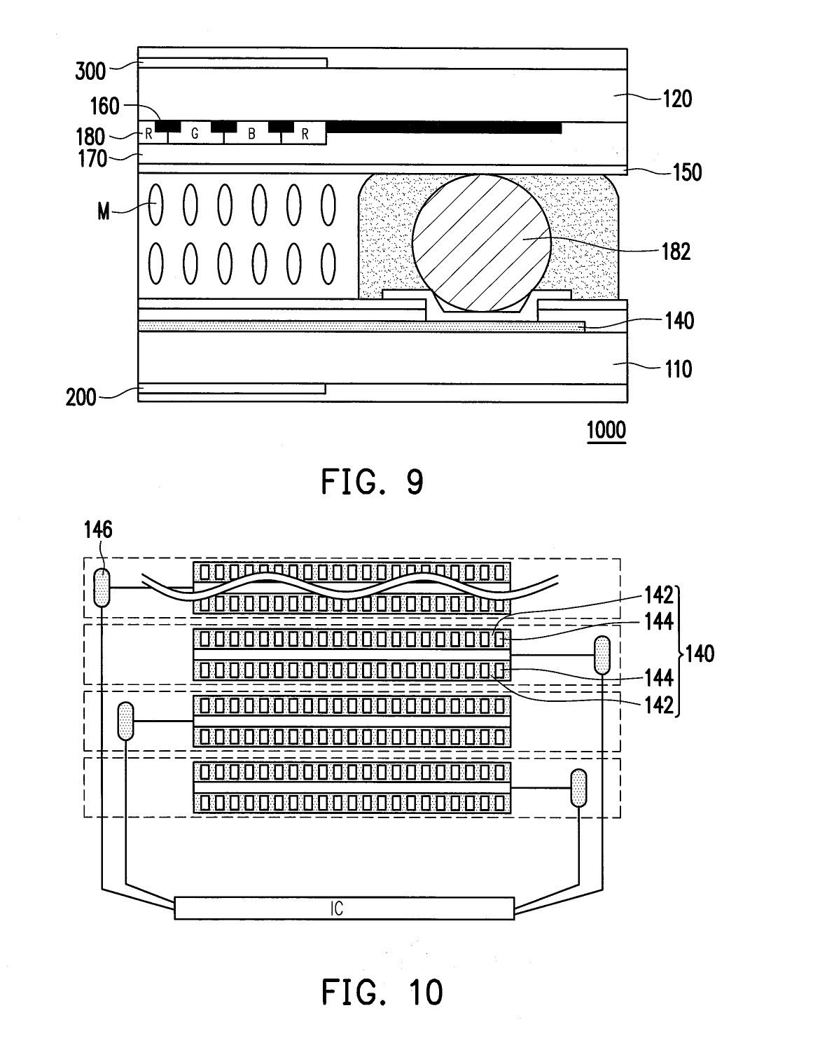

FIG. 9 is a cross-sectional diagram of a touch display device according to the first embodiment of the invention and FIG. 10 is a diagram showing the first common-electrode-structures of FIG. 9. Referring to FIGS. 9 and 10, to meet the need of display and touch function, the second common-electrode-patterns 150 are electrically connected to the first common-electrode-structures 140. The display panel of the embodiment can further include a plurality of conductive particles 182 between the first substrate 110 and the second substrate 120. Each of the first common-electrode-structures 140 further includes a first adapting-pad 146 electrically connected to a plurality of first common-electrode-patterns 142 in each of the first common-electrode-structures 140 (shown in FIG. 10). Similarly, each of the second common-electrode-patterns 150 further includes a second adapting-pad (not shown) electrically connected to each of the second common-electrode-patterns 150. The first adapting-pad 146 is electrically connected to the second adapting-pad (and the second common-electrode-patterns 150) through the conductive particles 182.

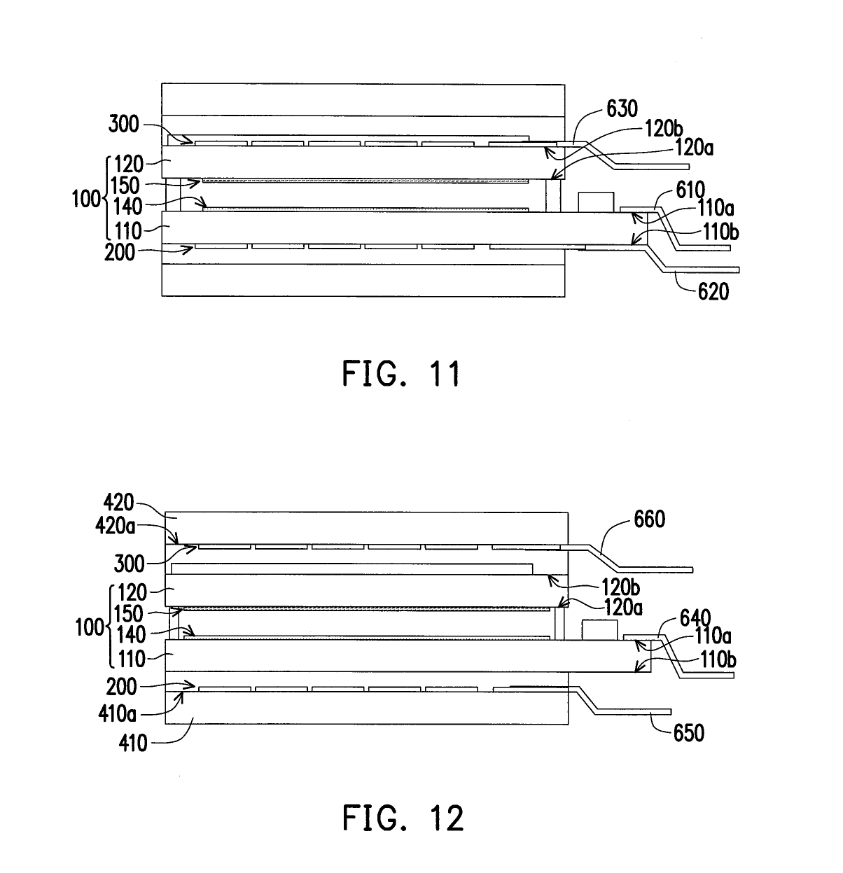

FIG. 11 is a cross-sectional diagram of a touch display panel after modularization according to the first embodiment of the invention. Referring to FIG. 11, in the embodiment, the first common-electrode-structures 140 and the first sensing-series 200 are located on the first substrate 110. The second common-electrode-patterns 150 and the second sensing-series 300 are located on the second substrate 120. For driving the display panel 100 (formed by the first common-electrode-structures 140, the second common-electrode-patterns 150, the unshown pixel structures and the unshown display medium), the first touch-sensing layer (formed by the first common-electrode-structures 140 and the first sensing-series 200) and the second touch-sensing layer (formed by the second common-electrode-patterns 150 and the second sensing-series 300), the first inner-surface 110a of the first substrate 110 can adhere onto a flexible circuit board (FCB) 610 electrically connected to the display panel 100, the first outer-surface 110b of the first substrate 110 can adhere onto an FCB 620 electrically connected to the first touch-sensing layer and the second outer-surface 120b of the second substrate 120 can adhere onto an FCB 630 electrically connected to the second touch-sensing layer. The FCB 610 is configured for inputting the displaying signal and the signals of driving the first touch-sensing layer and the second touch-sensing layer, and the FCBs 620 and 630 are configured for reading out the touch signals sensed by the first touch-sensing layer and the second touch-sensing layer.

FIG. 12 is a cross-sectional diagram of a touch display panel after modularization according to another embodiment of the invention. Referring to FIG. 12, in the embodiment, the first common-electrode-structures 140 and the second common-electrode-patterns 150 are respectively located on the first substrate 110 and the second substrate 120. In particular, the first sensing-series 200 are located on the first transparent protection plate 410 and the second sensing-series 300 are is located on the second transparent protection plate 420. Similarly, for driving the display panel 100, the first touch-sensing layer (formed by the first common-electrode-structures 140 and the first sensing-series 200) and the second touch-sensing layer (formed by the second common-electrode-patterns 150 and the second sensing-series 300), the first inner-surface 110a of the first substrate 110 can adhere onto an FCB 640, the surface 410a of the first transparent protection plate 410 adhere onto an FCB 650 and the surface 420a of the second transparent protection plate 420 can adhere onto an FCB 660. The FCB 640 is configured for inputting the displaying signal and the signals of driving the first touch-sensing layer and the second touch-sensing layer, and the FCBs 650 and 660 are configured for reading out the touch signals sensed by the first touch-sensing layer and the second touch-sensing layer.

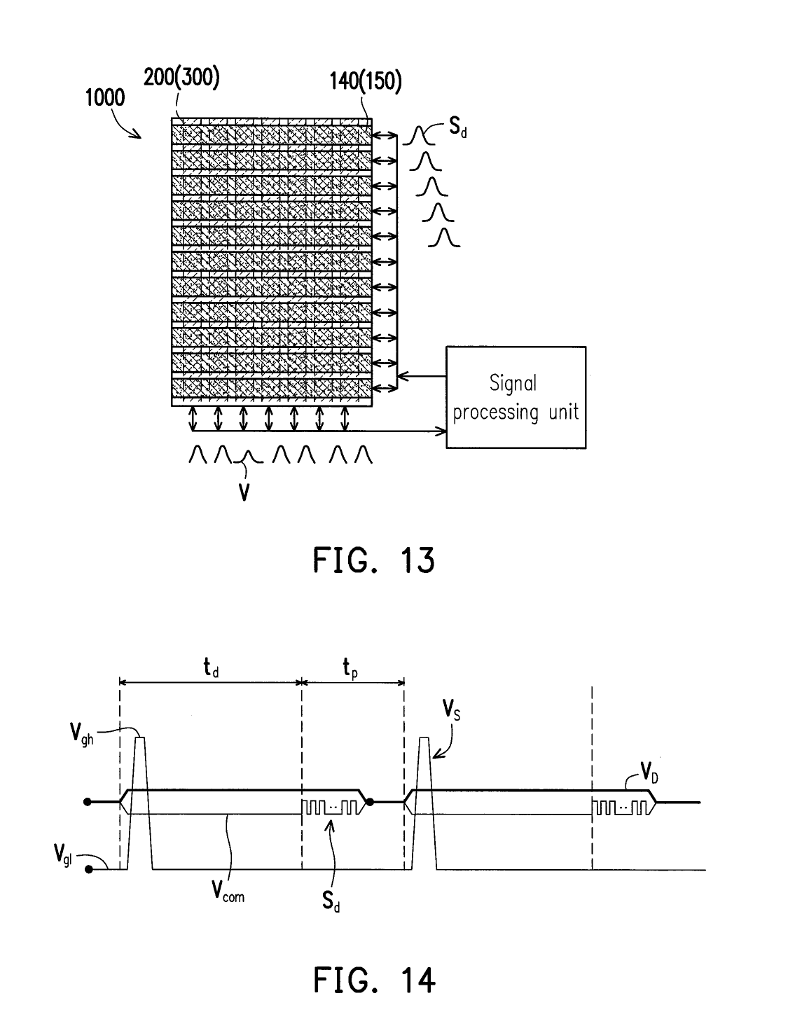

The driving method of the touch display device 1000 of the embodiment is explained in association with FIGS. 13 and 14 in following. In the embodiment, the first common-electrode-structures 140 and the second common-electrode-patterns 150 provide the display medium (not shown) with a reference voltage. On the other hand, the first common-electrode-structures 140 and the second common-electrode-patterns 150 serve as the driving electrodes of the first touch-sensing layer and the second touch-sensing layer and the first sensing-series 200 and the second sensing-series 300 respectively serve as the reading electrodes of the first touch-sensing layer and the second touch-sensing layer, which the invention is not limited to. In other embodiments, the first common-electrode-structures 140 and the second common-electrode-patterns 150 can also respectively serve as the reading electrodes of the first touch-sensing layer and the second touch-sensing layer, while the first sensing-series 200 and the second sensing-series 300 can respectively serve as the driving electrodes of the first touch-sensing layer and the second touch-sensing layer.

FIG. 13 is a driving diagram of the touch display device according to the first embodiment of the invention. As shown by FIG. 13, a sensing driving-signals S_{d} is sequentially input to each of the first common-electrode-structures 140 (and the second common-electrode-patterns 150). When the user touches the touch display device 1000, the capacitance between the first common-electrode-structures 140 and the first sensing-series 200 (or between the second common-electrode-patterns 150 and the second sensing-series 300) would be changed, so that the voltage waveform V read by the first sensing-series 200 (or the second sensing-series 300) get changed as well. In this way, through a signal processing unit, the touch display device 1000 of the embodiment can obtain the touching position of the user and accordingly make a response.

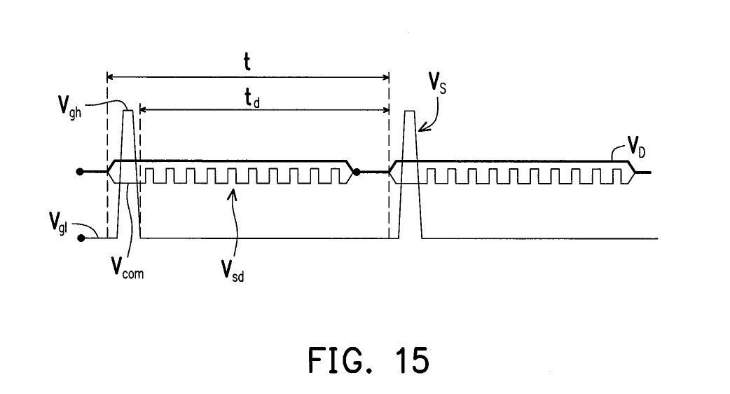

It should be noted that the first common-electrode-structures 140 and the second common-electrode-patterns 150 of the embodiment respectively require the sensing driving-signals S_{d} by inputting and are also in charge of providing the pixel structures 130 with the reference voltage so as to enable the touch display device 1000 having touch function and display function. In order to avoid the sensing driving-signals S_{d} of the first common-electrode-structures 140 and the second common-electrode-patterns 150 from affecting the display function of the pixel structures 130, a driving method of the touch display device in the embodiment is provided, referring to FIGS. 14 and 15.

FIG. 14 is a diagram showing the sensing driving-signal S_{d} and the reference voltage Vcom input to the first common-electrode-structures and the second common-electrode-patterns, the scan signal Vs input to the gates of the pixel structures and the displaying signal V_{D} input to the sources of the pixel structures according to the first embodiment of the invention. In the embodiment, a plurality of sensing driving-signals S_{d} can be input to the first common-electrode-structures 140 and the second common-electrode-patterns 150 after each frame-updating duration t_{d} but prior to the next frame-updating duration, i.e., within the duration tₚ. In particular, during the duration tₚ of inputting the sensing driving-signals S_{d}, the pixel structures 130 are in turning-off state (i.e., the scan signal Vs of the gates G of the pixel structures 130 takes a gate turning-off voltage Vgl). In this way, the touch display device of the embodiment has display function and touch function on double surfaces.

FIG. 15 is a diagram showing the sensing driving-signal S_{d} and the reference voltage Vcom input to the first common-electrode-structures and the second common-electrode-patterns, the scan signal Vs input to the gates of the pixel structures and the displaying signal V_{D} input to the sources of the pixel structures according to another embodiment of the invention. In the embodiment, a plurality of sensing driving-signals S_{d} can be input to the first common-electrode-structures 140 and the second common-electrode-patterns 150 in a fixed frequency within a frame-updating duration t, in which during the duration t_{d} of inputting the sensing driving-signals S_{d}, the pixel structures 130 are in turning-off state. In this way, the touch display device of the embodiment has display function and touch function on double surfaces.

### The Second Embodiment

The touch display device of the embodiment is similar to the touch display device of the first embodiment and thus the same components are marked with the same notations. The major difference of the touch display device in the embodiment from the touch display device of the first embodiment is the display panel. In more details, in the display panel of the embodiment, the display medium is made of self-luminous material, for example, organic light emitted diode (OLED). In addition, in the display panel of the embodiment, the design of the pixel structures and the position of the second common-electrode-patterns are also different from the first embodiment. In following the differences are described, while the same design is omitted to describe.

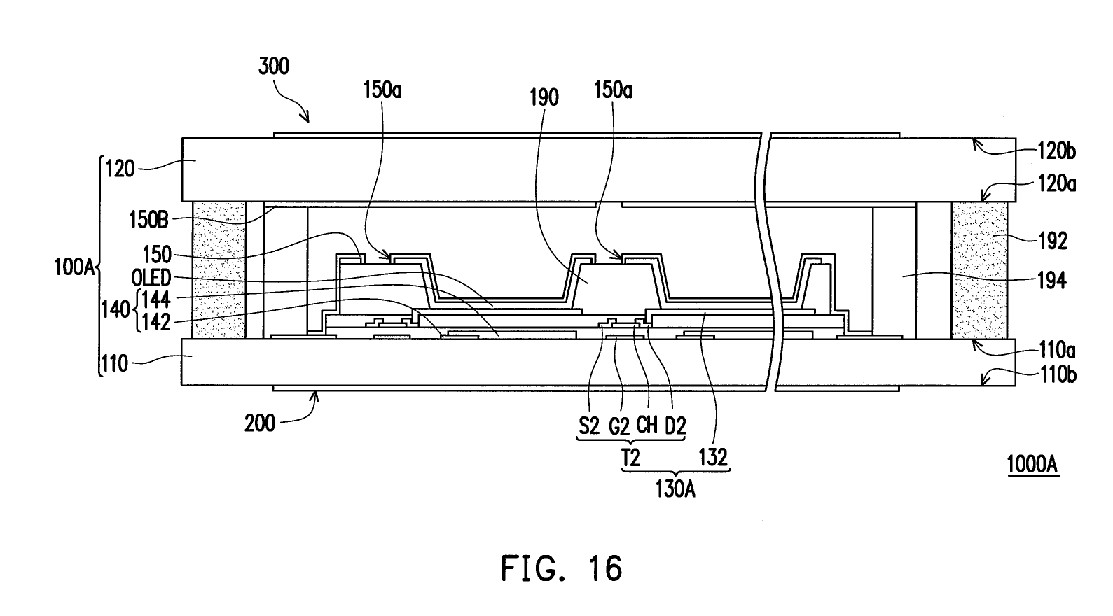

FIG. 16 is a cross-sectional diagram of a touch display device according to the second embodiment of the invention. Referring to FIG. 16, a touch display device 1000A of the embodiment includes a display panel 100A, a plurality of first sensing-series 200 and a plurality of second sensing-series 300. The display panel includes a first substrate 110, a second substrate 120, a plurality of pixel structures 130A, a plurality of first common-electrode-structures 140, a plurality of second common-electrode-patterns 150 and a display medium OLED. The first substrate 110 has a first inner-surface 110a and a first outer-surface 110b, the second substrate has a second inner-surface 120a and a second outer-surface 120b, and the pixel structures 130A are located between the first inner-surface 110a and the second inner-surface 120a. The first common-electrode-structures 140 are located between the first inner-surface 110a and the pixel structures 130A and are electrically insulated from each other. Each of the first common-electrode-structures 140 includes a plurality of first common-electrode-patterns 142 electrically connected to each other. The second common-electrode-patterns 150 are located between the pixel structures 130A and the second inner-surface 120a. The second common-electrode-patterns 150 are electrically insulated from each other and respectively electrically connected to the first common-electrode-structures 140. The display medium OLED is located between the first substrate 110 and the second substrate 120. The first outer-surface 110b is located between the first sensing-series 200 and the first inner-surface 110a. The first sensing-series 200 are electrically insulated from each other and crossed with the first common-electrode-structures 140. The second outer-surface 120b is located between the second sensing-series 300 and the second inner-surface 120a. The second sensing-series 300 are electrically insulated from each other and crossed with the second common-electrode-patterns 150.

Similarly to the first embodiment, in order to increase the coupling area between the first common-electrode-structures 140 and the first sensing-series 200, each of the first common-electrode-structures 140 in the embodiment can further include a plurality of transparent electrodes 144 located between the pixel structures 130A and the first inner-surface 110a, and the transparent electrodes 144 are electrically connected to a plurality of first common-electrode-patterns 142 in the first common-electrode-structures 140. The first common-electrode-structures 140 and the first sensing-series 200 form a first touch-sensing layer and the second common-electrode-patterns 150 and the second sensing-series 300 form a second touch-sensing layer, in which the first touch-sensing layer and the second touch-sensing layer are provided to a user beside the first substrate 110 and another user beside the second substrate 120 for touch operating. Since the display panel of the embodiment can display on double surfaces, the second common-electrode-patterns 150, in addition to the transparent electrodes 144, should be made of transparent conductive material.

Different from the first embodiment, the material of the display medium OLED in the embodiment is self-luminous material, for example, OLED, and the OLED is a current driving component, so that the pixel structures 130A of the embodiment has some differences from the pixel structures 130 of the first embodiment, as shown by FIG. 17.

FIG. 17 is an equivalent circuit diagram of the display panel of FIG. 16. Referring to FIG. 17, each of the pixel structures 130A of the embodiment includes a data line DL, a scan line SL, a selection transistor T1, a driving transistor T2 and a pixel electrode 132. In the embodiment, the source S1 of the selection transistor T1 is electrically connected to the data line DL. The gate G1 of the selection transistor T1 is electrically connected to the scan line SL. The drain D1 of the selection transistor T1 is electrically connected to the gate G2 of the driving transistor T2. The source S2 of the driving transistor T2 is electrically connected to a constant voltage V_{DD}. The drain D2 of the driving transistor T2 is electrically connected to the display medium OLED. The corresponding first common-electrode-structure 140 and the gate G2 of the driving transistor T2 form a storage capacitor C1. The second common-electrode-patterns 150 are electrically connected to the display medium OLED and the first common-electrode-structures 140.

In more details, in the embodiment, the signal input from the scan line SL to the gate G1 turns on or off the selection transistor T1. When the selection transistor T1 is turned on, the displaying signal can be transmitted to the drain D1 of the selection transistor T1 from the data line DL to further turn on the driving transistor T2. When the driving transistor T2 is turned on, both ends of the display medium OLED (i.e., an end of the display medium OLED connected to the drain D2 of the driving transistor T2 and another end of the display medium OLED connected to the second common-electrode-patterns 150) have a voltage difference therebetween. The voltage difference enables the current flowing through the display medium OLED to make the display medium OLED display with a graylevel corresponding to the displaying signal. It should be noted that the pixel structures 130A of the embodiment is a two-transistors and one-capacitor structure (2T1C), which the invention is not limited to. In other embodiments, the pixel structures 130A can be a three-transistors one-capacitor structure (3T1C), a four-transistors one-capacitor structure (4T1C), a four-transistors two-capacitors structure (4T2C) or a five-transistors and one-capacitor structure (5T1C) or other appropriate structures.

In addition, the position of the second common-electrode-patterns 150 of the embodiment is different from the first embodiment. As shown by FIG. 1, in the first embodiment, the second common-electrode-patterns 150 are located on the second inner-surface 120a of the second substrate 120, but in the second embodiment, as shown by FIG. 16, the second common-electrode-patterns 150 are located on the first inner-surface 110a of the first substrate 110.

Moreover, the display panel 100A of the embodiment can include a plurality of barrier-walls 190. The barrier-walls 190 are located on the driving transistors T2 of the pixel structures 130A and the display medium OLED is located between the second common-electrode-patterns 150 and the barrier-walls 190. Each of the second common-electrode-patterns 150 has at least one edge 150a adjacent to other second common-electrode-patterns 150, and the barrier-walls 190 cover the edges 150a. As a result, the profile of the second common-electrode-patterns 150 is not easily noticed by the user, which further advances the visual uniformity of the touch display device 1000A.

Referring to FIG. 16 again, in order to increase the coupling capacitance between the second common-electrode-patterns 150 and the second sensing-series 300 and thereby the touch effect of the touch display device 1000A, the touch display device 1000A of the embodiment can further include a plurality of third common-electrode-patterns 150B electrically insulated from each other. The orthogonal projection of the third common-electrode-patterns 150B on the second inner-surface 120a and the orthogonal projection of the second common-electrode-patterns 150 on the second inner-surface 120a are substantially coincided by each other. Each of the second common-electrode-patterns 150 is respectively electrically connected to an opposite one of the third common-electrode-patterns 150B. Since the third common-electrode-patterns 150B have shorter distances from the second sensing-series 300 and the second common-electrode-patterns 150 are electrically connected to the third common-electrode-patterns 150B, the coupling capacitance between the second common-electrode-patterns 150 and the second sensing-series 300 gets larger, so that the sensing effect of the second touch-sensing layer formed by the second common-electrode-patterns 150, the second sensing-series 300 and the third common-electrode-patterns 150B gets better.

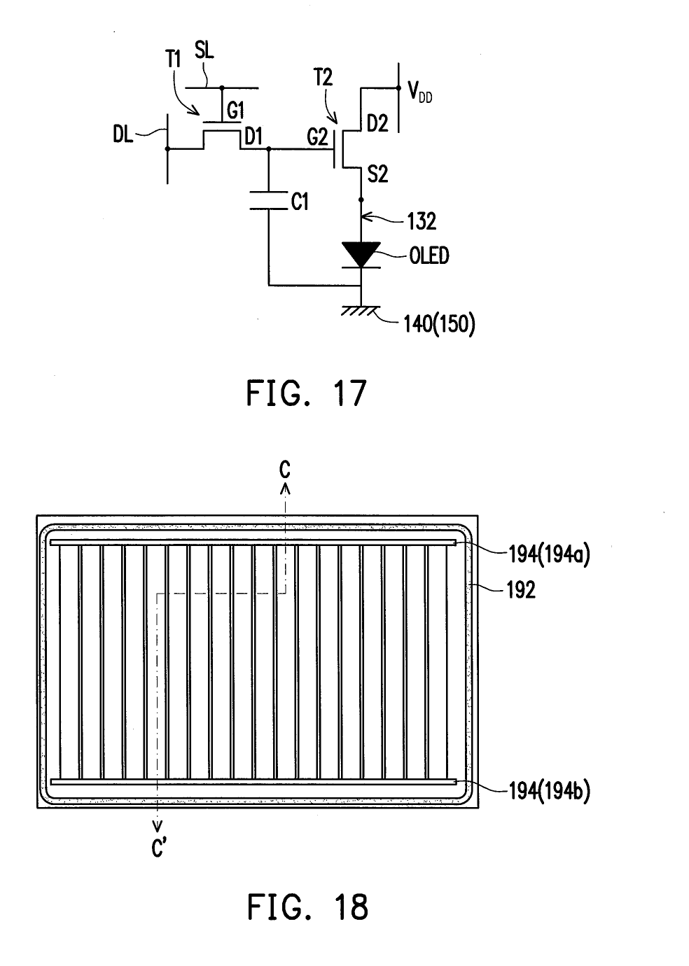

FIG. 18 is a top-view perspective diagram of the touch display device of FIG. 16, in which FIG. 16 is corresponding to the sectional line CC′ of FIG. 18. Referring to FIGS. 16 and 18, the display panel 100A of the embodiment can further include an encapsulant 192 and a conductive glue 194. The encapsulant 192 surrounds all the pixel structures 130A and is located between the first substrate 110 and the second substrate 120. The encapsulant 192 is mainly for joining the first substrate 110 and the second substrate 120 and supporting the first substrate 110 from the second substrate 120 to keep a gap between the first substrate 110 and the second substrate 120. In other words, the encapsulant 192, the first substrate 110 and the second substrate 120 together enclose the area where the display medium OLED is located to avoid the external moisture from entering into the display panel 100A to affect the lifetime of the display panel 100A. The conductive glue 194 includes two conductive tapes 194a and 194b. The conductive tapes 194a and 194b are located between the second common-electrode-patterns 150A and the third common-electrode-patterns 150B and respectively disposed at both ends of each of the second common-electrode-patterns 150A (and both ends of the third common-electrode-patterns 150B), so that each of the second common-electrode-patterns 150A is respectively electrically connected to an opposite one of the third common-electrode-patterns 150B.

The touch display device 1000A of the embodiment can use a driving method similar to the driving method of the touch display device 1000B in the first embodiment, which is omitted to describe. In short, in addition to having the function and the advantage of the touch display device 1000 of the first embodiment, the touch display device 1000A of the embodiment, since its display medium OLED is a self-luminous material, does not need an additional backlight source, so that the touch display device 1000A is more easy for slimming and able to avoid the light reflection problem between the LGP and the first sensing-series 200 and the second sensing-series 300 or between the internal structures of the display panel 100A.

In summary, according to an embodiment of the invention, the touch display panel has a first touch-sensing layer formed by two sets of the sensing-series with different extending directions and respectively disposed at the inner side and the outer side of the first substrate of the display panel and a second touch-sensing layer formed by another two sets of the sensing-series with different extending directions and respectively disposed at the inner side and the outer side of the second substrate of the display panel. As a result, at least two users at both sides of the touch display device can respectively use the first touch-sensing layer and the second touch-sensing layer for operating the touch display device of the invention, which makes the two users interactive operations more conveniently and more quickly.

Moreover and more important, in the touch display device, according to an embodiment of the invention, the two sets of the sensing-series located at the inner sides of the first substrate and the second substrate are fabricated respectively by using the first common-electrode-structures and the second common-electrode-patterns, so that the touch display device in an embodiment of the invention can be touch operated on double surface. In addition, an embodiment of the invention provides a specific driving method able to make the touch display device have display function and touch function.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A touch display device, comprising:
a display panel, comprising:
a first substrate, having a first inner-surface and a first outer-surface opposite to the first inner-surface;
a second substrate, having a second inner-surface and a second outer-surface opposite to the second inner-surface;
a plurality of pixel structures, located between the first inner-surface and the second inner-surface;
a display medium, located between the first substrate and the second substrate;
a plurality of first sensing-series, wherein the first outer-surface is located between the first sensing-series and the first inner-surface, and the first sensing-series are insulated from each other; and
a plurality of second sensing-series, wherein the second outer-surface is located between the second sensing-series and the second inner-surface, and the second sensing-series are electrically insulated from each other.

2. The touch display device as claimed in claim 1, further comprising
a plurality of first electrode-structures, located between the first inner-surface and the pixel structures, wherein the first electrode-structures are electrically insulated from each other;
a plurality of second electrode-patterns, located between the pixel structures and the second inner-surface, wherein the second electrode-patterns are electrically insulated from each other; and
the first sensing-series crossed with the first electrode-structures, and the second sensing-series crossed with the second electrode-patterns.

3. The touch display device as claimed in claim 2, wherein the first electrode-structures are the first common-electrode-structures and each of the first common-electrode-structures comprises a plurality of first common-electrode-patterns electrically connected to each other, and the second electrode-patterns are the second common-electrode-patterns.

4. The touch display device as claimed in claim 3, wherein the second common-electrode-patterns are respectively electrically connected to the first common-electrode-structures.

5. The touch display device as claimed in claim 3, wherein each of the first common-electrode-structures further comprises a plurality of transparent electrodes located between the pixel structure and the first inner-surface, and the transparent electrodes are respectively electrically connected to the first common-electrode-patterns of first common-electrode-structure.

6. The touch display device as claimed in claim 3, wherein the display panel further comprises a light-shielding layer, the light-shielding layer is located between the second inner-surface and the second common-electrode-patterns, each of the second common-electrode-patterns has at least one edge adjacent to the other second common-electrode-patterns and the light-shielding layer covers the edge.

7. The touch display device as claimed in claim 6, wherein the display panel further comprises a passivation layer, and the passivation layer entirely overlays the light-shielding layer and is located between the second common-electrode-patterns and the light-shielding layer.

8. The touch display device as claimed in claim 3, wherein the display medium is organic light emitted diode (OLED), the display panel further comprises a plurality of barrier-walls, the barrier-walls are respectively located on the pixel structures, each of the second common-electrode-patterns has at least one edge adjacent to the other second common-electrode-patterns and the barrier-walls respectively cover the edges.

9. The touch display device as claimed in claim 1, further comprising a plurality of first dummy sensing-pads and a plurality of second dummy sensing-pads, wherein the first dummy sensing-pads are located at gap places between the first sensing-series, and the second dummy sensing-pads are located at gap places between the second sensing-series.

10. The touch display device as claimed in claim 1, wherein the first sensing-series contact the first outer-surface, and the second sensing-series contact the second outer-surface.

11. The touch display device as claimed in claim 1, further comprising a first light guide plate (LGP), a second light guide plate and at least two light-emitting components respectively located beside the first light guide plate and the second light guide plate, the first outer-surface is located between the first light guide plate and the first inner-surface, and the second outer-surface is located between the second light guide plate and the second inner-surface.

12. The touch display device as claimed in claim 11, wherein the first sensing-series contact the first light guide plate and the second sensing-series contact the second light guide plate.

13. The touch display device as claimed in claim 1, further comprising a first transparent protection plate and a second transparent protection plate, wherein the first outer-surface is located between the first inner-surface and the first transparent protection plate, and the second outer-surface is located between the second inner-surface and the second transparent protection plate.

14. The touch display device as claimed in claim 13, wherein the first sensing-series contact the first transparent protection plate, and the second sensing-series contact the second transparent protection plate.

15. The touch display device as claimed in claim 4, wherein the display panel further comprises a plurality of conductive particles located between the first substrate and the second substrate, each of the first common-electrode-structures further comprises a first adapting-pad electrically connected to the first common-electrode-patterns of the first common-electrode-structure, and each of the second common-electrode-patterns further comprises a second adapting-pad and the first adapting-pad is electrically connected to the second adapting-pad via the conductive particles.

16. The touch display device as claimed in claim 2, wherein extension direction of the first sensing-series and extension direction of the second sensing-series are substantially parallel to each other, and extension direction of the first electrode-structures and extension direction of the second electrode-patterns are substantially parallel to each other.

17. The touch display device as claimed in claim 3, wherein the display medium is organic light emitted diode (OLED), the display panel further comprises a plurality of third common-electrode-patterns electrically insulated from each other, orthogonal projections of the third common-electrode-patterns on the second inner-surface and orthogonal projections of the second common-electrode-patterns on the second inner-surface are substantially coincided with each other, and each of the second common-electrode-patterns is respectively electrically connected to one of the opposite third common-electrode-patterns.

18. A driving method of a touch display device, suitable for driving a touch display device comprising:
a display panel, comprising:
a first substrate, having a first inner-surface and a first outer-surface opposite to the first inner-surface;
a second substrate, having a second inner-surface and a second outer-surface opposite to the second inner-surface;
a plurality of pixel structures, located between the first inner-surface and the second inner-surface;
a plurality of first electrode-structures, located between the first inner-surface and the pixel structures, wherein the first electrode-structures are electrically insulated from each other;
a display medium, located between the first substrate and the second substrate;
a plurality of first sensing-series, wherein the first outer-surface is located between the first sensing-series and the first inner-surface, and the first sensing-series are insulated from each other; and
a plurality of second sensing-series, wherein the second outer-surface is located between the second sensing-series and the second inner-surface, and the second sensing-series are electrically insulated from each other, wherein the driving method comprises: respectively inputting a plurality of sensing driving-signals in a fixed frequency within a frame-updating duration to the first electrode-structures, wherein a plurality of active devices of the pixel structures during inputting the sensing driving-signals are in turning-off state.

19. A driving method of a touch display device, suitable for driving a touch display device comprising:
a display panel, comprising:
a first substrate, having a first inner-surface and a first outer-surface opposite to the first inner-surface;
a second substrate, having a second inner-surface and a second outer-surface opposite to the second inner-surface;
a plurality of pixel structures, located between the first inner-surface and the second inner-surface;
a plurality of first electrode-structures, located between the first inner-surface and the pixel structures, wherein the first electrode-structures are electrically insulated from each other;
a display medium, located between the first substrate and the second substrate;
a plurality of first sensing-series, wherein the first outer-surface is located between the first sensing-series and the first inner-surface, and the first sensing-series are insulated from each other; and
a plurality of second sensing-series, wherein the second outer-surface is located between the second sensing-series and the second inner-surface, and the second sensing-series are electrically insulated from each other, wherein the driving method comprises: respectively inputting a plurality of sensing driving-signals to the first electrode-structures after updating a frame but prior to updating the next frame, wherein a plurality of active devices of the pixel structures during inputting the sensing driving-signals are in turning-off state.
